(19) United States
(12) Patent Application Publication
(10) Pub. No.: US 2009/0102960 A1
(43) Pub. Date: Apr. 23, 2009

(54) IMAGE PICKUP APPARATUS

(75) Inventor: Hitoshi TSUCHIYA, Hamura-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/211,336

(22) Filed: Sep. 16, 2008

(30) Foreign Application Priority Data
Oct. 23, 2007 (JP) 2007-275447

(51) Int. Cl. H04N 5/232

(52) U.S. Cl. 348/345; 348/E05.042

(57) ABSTRACT

An image pickup apparatus includes an optical system which forms an image of a shooting subject. A driving section drives the optical system. A focus operation section transmits a driving direction and a driving amount of the optical system on the basis of a manual operation. An image pickup element converts the image of the shooting subject formed by the optical system into a video signal. An evaluation section evaluates a focus condition of at least one area within a photographing field on the basis of the video signal from the image pickup element. An autofocus adjustment section selects an area which is determined to be focused as a result of the evaluation of the focus condition and drives the optical system to a position corresponding to the area determined to be focused.

### CROSS-REFERENCE TO RELATED APPLICATIONS

This application is based upon and claims the benefit of priority from prior Japanese Patent Application No. 2007-275447, filed Oct. 23, 2007, the entire contents of which are incorporated herein by reference.

### BACKGROUND OF THE INVENTION

1. Field of the Invention

The present invention relates to an image pickup apparatus having a mechanism which performs focus adjustment of an optical system on the basis of a video signal from an image pickup element.

2. Description of the Related Art

In recent years, digital single-lens reflex cameras employing an electronic finder function (also called as a live view function) are becoming popular. The electronic finder function enables a display of a subject image on a display panel provided on the back side of a camera, etc. so as to be used instead of a finder.

A camera having the electronic finder function is able to display a subject image on its display panel. This function enables a user to check a shooting subject or a composition without looking through a finder. Therefore, a user is able to take photos while checking images without assuming difficult postures, even during a particular photographing such as a photographing in which a camera is placed at a high position or a photographing performed closed to the ground. Furthermore, since the camera having the electronic finder function displays a shooting subject as an electronic image, a user can check various types of information, including a case where details are dropped out in a shadow and turned black, or a case where highlights are over-exposed.

Generally, single-lens reflex cameras have two focus adjustment modes for focus adjustment: a manual focus mode for manually adjusting focus; and an autofocus mode for automatically adjusting focus by detecting focus misalignment with an autofocus (AF) sensor mounted in the camera.

Generally, a single-lens reflex camera having a live view function does not allow use of an AF sensor while the live view function is operating. In such a case, a manual focus mode is used, or an autofocus mode using an AF sensor is executed after stopping the live view function.

In the above case, there is a problem that both of the approaches require time for focus adjustment. In order to solve the problem, application of an autofocus system utilizing a contrast detection method, which is used in a compact camera, to a single-lens reflex camera is therefore considered.

The contrast detection method is a method for detecting a focused position of a focus lens in such a manner that while moving the focus lens, contrast of video signals from an image pickup element corresponding to respective lens positions is calculated, and a peak of the calculated contrast is detected. When an autofocus utilizing the contrast detection method is applied to a single-lens reflex camera, a blur of a shooting subject tends to be worse. It is because the focal length of a single-lens reflex camera is longer than that of a compact camera that the focus adjustable range of the single-lens reflex camera is wide. Thus, it may cause a totally blurred image in which none of the shooting subject is focused when focus adjustment is performed based on contrast over the whole photographing field, as is performed in compact cameras.

In order to solve the above problem, various methods by which focus adjustment is performed on the basis of contrast of a part of a photographing field have been proposed for photographing an image wherein a target shooting subject is focused. For example, Jpn. Pat. Appln. KOKAI Publication No. 1-288845 discloses, as a method for selecting a part of a photographing field, and a camera whose body is provided with a configuration dial or the like for selecting a field of view. The camera disclosed in Jpn. Pat. Appln. KOKAI Publication No. 1-288845 is configured to be able to switch focus areas, which is superimposedly displayed within the field of view, in a driving direction of the configuration dial or the like, by rotationally operating the configuration dial or the like. According to the disclosed camera, a focus area is sequentially switched and selected in the driving direction of the configuration dial or the like. Therefore, the disclosed camera has an advantage in which an operation of the configuration dial or the like can be recognized such that it is intuitively associated with switch of the focus area.

### BRIEF SUMMARY OF THE INVENTION

According to an aspect of the invention, there is provided an image pickup apparatus comprising: an optical system which forms an image of a shooting subject; a driving section which drives the optical system; a focus operation section which transmits a driving direction and a driving amount of the optical system on the basis of a manual operation; an image pickup element which converts the image of the shooting subject formed by the optical system into a video signal; an evaluation section which evaluates a focus condition of at least one area within a photographing field on the basis of the video signal from the image pickup element; and an autofocus adjustment section which adjusts focus of the optical system in such a manner that the autofocus adjustment section selects an area which is determined to be focused as a result of the evaluation of the focus condition of at least one area performed by the evaluation section in conjunction with driving of the optical system by the focus operation section on the basis of a manual operation, and drives the optical system to a position corresponding to the area determined to be focused.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIGS. 1A and 1B are drawings showing a configuration of a digital single-lens reflex camera which is disclosed as an example of an image pickup apparatus according to the first embodiment of the present invention;

FIG. 2 is an external perspective view of the single-lens reflex camera shown in FIGS. 1A and 1B;

FIG. 3 is a flowchart indicating processing of a system controller performed during a semi-autofocus mode according to the first embodiment;

FIG. 4 is a drawing for showing an example of focus indicators;

FIG. 5 is a chart showing relationships between positions of a focus lens and evaluation values, which correspond to respective focus adjustment areas;

FIG. 6 is a flowchart indicating processing of a lens CPU performed during the semi-autofocus mode according to the first embodiment;

FIG. 7 is a flowchart indicating focus-ring-stop determination processing;

FIG. 8 is a drawing for showing an example of a superimposed display of information related to focus other than the in-focus condition; and

FIG. 9 is a flowchart indicating processing of a lens CPU performed during a semi-autofocus mode according to the second embodiment.

### DETAILED DESCRIPTION OF THE INVENTION

Now, an embodiment of the present invention will be described with reference to the accompanying drawings.

### First Embodiment

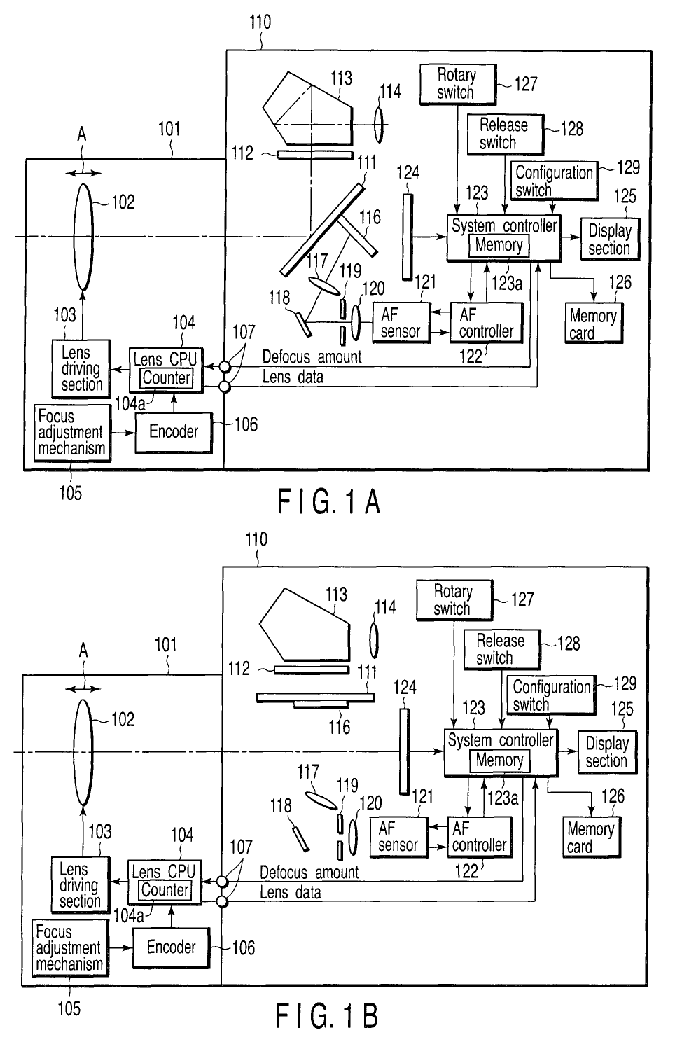

First, the first embodiment of the present invention will be explained. FIGS. 1A and 1B are drawings each of which shows a configuration of a digital single-lens reflex camera (hereinafter arbitrarily referred to as “camera”) as an example of an image pickup apparatus according to the first embodiment of the present invention. In FIGS. 1A and 1B, a camera in which an autofocus mode, a manual focus mode, and a semi-autofocus mode are selectable is assumed. The autofocus mode is a mode in which all of the processing related to autofocus adjustment of a photographing optical system is performed automatically. The manual focus mode is a mode in which a user manually performs focus adjustment of the photographing optical system. The semi-autofocus mode is a mode between the autofocus mode and the manual focus mode. In the semi-autofocus mode, a user manually performs basic focus adjustment (selection of a shooting subject), and detailed focus adjustment on the selected shooting subject is performed automatically.

Prior to a detailed explanation of the first embodiment of the present invention, a focus adjustment mechanism for a camera will be explained. FIG. 1A is a drawing showing a condition during a normal focus operation, and FIG. 1B is a drawing showing a condition during photographing or during the live view function operation.

The camera of the present embodiment includes an interchangeable lens 101 and a camera body 110.

The interchangeable lens 101 is configured to be detachable from the camera body 110 via a camera mount which is not shown. The camera mount is provided on a front side of the camera body 110. The interchangeable lens 101 includes a photographing optical system comprising a focus lens 102 and the like, a lens driving section 103, a lens CPU 104, a focus adjustment mechanism 105, and an encoder 106.

The focus lens 102 is a lens included in the photographing optical system, for performing focus adjustment. This focus lens 102 is driven in an optical axis direction (arrow A direction shown in FIGS. 1A and 1B) by the lens driving section 103, so as to perform focus adjustment for the photographing optical system. As a result of the focus adjustment, a beam from a shooting subject (not shown) that has passed through the photographing optical system forms an in-focus image on an image pickup element 124 in the camera body 110.

The lens driving section 103 drives the focus lens 102 with, for example, a DC motor in response to a pulse signal from the lens CPU 104.

The lens CPU 104 is a control circuit for performing control of the lens driving section 103. This lens CPU 104 is configured to be able to communicate with a system controller in the camera body, via a communication connector 107. For example, various lens information preliminarily stored in the lens CPU 104 is communicated from the lens CPU 104 to the system controller 123. This lens information includes information such as production tolerance information and aberration information of the focus lens.

The focus adjustment mechanism 105, which serves as a focus operation section, is an operation mechanism for a user to directly control driving of the focus lens 102 during the manual focus mode or the semi-autofocus mode. This focus adjustment mechanism 105 can provide a driving direction and a driving amount toward a close side or an infinity side. The infinity side means a side at which a distance between a principal point of the photographing optical system including the focus lens 102 and an imaging plane becomes short, that is to say, the right side in the drawings. The close side means a side at which a distance between the principal point of the photographing optical system including the focus lens 102 and the imaging plane becomes long, that is to say, the left side in the drawings. The encoder 106 detects the driving direction and the driving amount of the focus adjustment mechanism 105 as a pulse signal, and transmits the detected pulse signal to the lens CPU 104. The lens CPU 104 detects a driving direction and a driving amount of the focus lens 102 by counting pulse signals from the encoder 106, and controls the lens driving section 103 in such a way that the focus lens 102 is driven in accordance with the detected driving direction and the driving amount.

The camera body 110 comprises a finder optical system, a sub-mirror 116, an AF optical system, an AF sensor 121, an AF controller 122, a system controller 123, an image pickup element 124, a display section 125, a memory card 126, a rotary switch 127, a release switch 128, and a configuration switch 129. The finder optical system comprises a main mirror 111, a focusing screen 112, a pentaprism 113, and an eyepiece 114. Further, the AF optical system comprises a condenser lens 117, a total reflection mirror 118, a separator aperture 119, and a separator lens 120.

The main mirror 111 is configured to be rotatable, and its central part comprises a half mirror. The main mirror 111 reflects one part of a beam from a shooting subject (not shown) which is incident on the camera body 110 via the interchangeable lens 101 so as to transmit the one part of the beam when the main mirror is at a down position (shown in FIG. 1A). The beam reflected on the main mirror 111 forms an image on the focusing screen 112. The pentaprism 113 makes the image of the shooting subject formed on the focusing screen 112 incident on the eyepiece 114 into an upright image. The eyepiece 114 enlarges the image of the shooting subject from the pentaprism 113 for the user to check. With this mechanism, the user is able to check a condition of the shooting subject (not shown).

The sub-mirror 116 is provided on a back side of the half mirror part of the main mirror 111, and directs a beam, which is transmitted through the half mirror part of the main mirror 111, in the direction of the AF optical system.

The condenser lens 117 collects a beam which is reflected from the sub-mirror 116 to form an image on a first image plane (not shown), and directs the collected beam in the direction of the total reflection mirror 118. The total refection mirror 118 reflects a beam from the condenser lens 117 toward the AF sensor 121. The separator aperture 119 is provided before a front side of the AF sensor 121, and divides a beam from the total reflection mirror 118. The separator lens 120 collects the beams from the separator aperture 119 for forming images in the AF sensor 121.

The AF sensor 121 converts at least one pair of images of the shooting subject into video signals, respectively. At this point, the AF sensor 121 is able to detect focus conditions in the plurality of focus adjustment areas within the photographing field.

The AF controller 122 reads out at least one pair of video signals from the AF sensor 121, and calculates a distance value between two images from the read out video signals by performing, for example, correlation calculation. The system controller 123 controls the overall performance of the camera shown in FIG. 1. The system controller 123 also calculates, from the distance value between the two images, defocus amounts respectively corresponding to the focus adjustment areas. Subsequently, the system controller 123 selects a defocus amount that should be used for focus adjustment from among the calculated defocus amounts respectively corresponding to the plurality of the focus adjustment areas. The system controller 123 then transmits the selected defocus amount to the lens CPU 104. The lens CPU 104 performs focus adjustment of the focus lens 102 based on the defocus amount. The system controller 123 has a memory 123a for storing the defocus amounts calculated from the distance value between two images by the AF controller 122.

The image pickup element 124 converts an image of the shooting subject formed via the photographing optical system into a video signal when the main mirror 111 is removed from the optical axis as shown in FIG. 1B. When the image of the shooting subject is converted into a video signal by the image pickup element 124, the system controller 123 performs various types of image processing on the video signal obtained by the image pickup element 124. Subsequently, the system controller 123 displays a processed image on the display section 125, and stores the processed image in the memory card 126.

The rotary switch 127 switches conditions by operation of a rotating operation member provided on an exterior of the camera body 110. This rotary switch 127 provides the system controller 123 with an operation amount associated with the rotary operation. The release switch 128 is a switch for switching conditions by operation of a release button provided on the exterior of the camera body 110. This release switch 128 provides the system controller 123 with an instruction for starting AF and an instruction for starting photographing. The release switch comprises a first release switch and a second release switch. When the release button is pressed halfway, the first release switch is turned on and an instruction for starting AF is given to the system controller 123. When the release switch is fully pressed, the second release switch is turned on and an instruction for starting photographing is given to the system controller 123. The configuration switch 129 is a switch for switching conditions by operating a configuration button provided on the exterior of the camera body 110. This configuration switch 129 provides the system controller with various setting instructions from a user. According to the present embodiment, the configuration switch 129 is used for switching between autofocus mode, manual focus mode, and semi-autofocus mode.

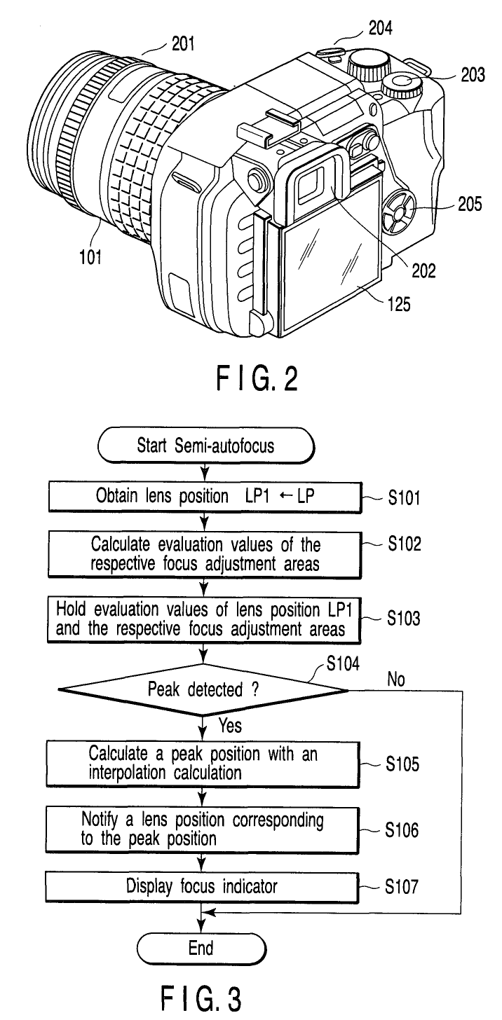

FIG. 2 is an external perspective view of the camera shown in FIGS. 1A and 1B. A focus ring 201 shown in FIG. 2, which is provided as a part of the focus adjustment mechanism 105 provided on the interchangeable lens 101, is operated by a user in rotary manner. A driving direction and a driving amount of the focus ring 201 are detected by the encoder 106. The finder 202 houses the eyepiece 114. The user can observe a shooting subject by looking through the finder 202. The rotary operation member 203, the release button 204, and the configuration button 205 are operation members for operating corresponding switches.

Now, operations of the camera according to the present embodiment will be explained.

First, a case wherein the configuration switch 129 is switched to the autofocus mode will be explained. The autofocus mode includes, for example, a single-shot autofocus mode, a continuous autofocus mode, etc. During the single-shot autofocus mode, one focus adjustment area is selected from among the plurality of focus adjustment areas within a photographing field in accordance with a predetermined algorithm, and focus adjustment is performed with respect to the selected focus adjustment area. The continuous autofocus mode is a mode suitable for photographing a moving subject. During the continuous autofocus mode, focus adjustment is performed while sequentially following a shooting subject specified by a user. In the explanation given below, a case in which an autofocus mode is the single-shot autofocus mode will be described.

When the release button 204 is pressed halfway and the first release switch is turned on, the system controller 123 controls the AF controller 122 for calculating distance values between two images of respective focus adjustment areas. The system controller 123 then calculates defocus amounts of the respective focus adjustment areas by using the distance values between two images. A detailed explanation of the calculation of defocus amounts will be omitted since existing methods may be used. When the plurality of defocus amounts are obtained with respect to the plurality of focus adjustment areas, the system controller 123 selects one defocus amount by using well-known algorithms such as weighting each of the focus adjustment areas or selecting the nearest focus adjustment area. Afterward, the system controller 123 notifies the lens CPU 104 of the defocus amount. The lens CPU 104 drives the focus lens 102 by controlling the lens driving section 103 in accordance with the notified defocus amount. With the above controls, focus adjustment of an arbitrary shooting subject is completed.

Next, a case in which the configuration switch 129 is switched to the manual focus mode will be explained.

When a user operates the focus ring 201 in a rotary manner, a driving direction and a driving amount of the focus ring 201 are detected by the encoder 106. Then, a signal indicating the driving direction and the driving amount of the focus ring 201 is notified to the lens CPU 104 from the encoder 106. The lens CPU 104 calculates a driving direction and a driving amount of the focus lens 102 out of the signal indicating the driving direction and the driving amount of the focus ring 201. Subsequently, the lens CPU 104 drives the focus lens 102 by controlling the lens driving section 103 in accordance with the above calculation result. With these controls, the focus lens 102 is driven in accordance with rotary operation of the focus ring 201 performed by the user.

Next, a case in which the configuration switch 129 is switched to the semi-autofocus mode will be explained. FIG. 3 is a flowchart indicating processing of the system controller 123 during the semi-autofocus mode according to the first embodiment. The processing of FIG. 3 is performed every predetermined period of time from the start of the semi-autofocus mode. Also, it is assumed that a user performs focus adjustment on a desired shooting subject by rotating the focus ring 201 during the semi-autofocus mode. Furthermore, it is assumed that the user observes the shooting subject by using the live view function during the semi-autofocus mode, since the main mirror 111 is removed from the optical axis of the photographing optical system as shown in FIG. 1B.

When a start of the semi-autofocus mode is detected, the system controller 123 communicates with the lens CPU 104 of the interchangeable lens 101. Then, the system controller 123 obtains a present position LP of the focus lens 102, and holds the obtained position LP of the focus lens 102 as a present lens position LP1 in the memory 123a (step S101). Initially, the position of the focus lens 102 is unknown. The system controller 123 therefore holds a value corresponding to a predetermined position (e.g., 0).

In addition, the start of the semi-autofocus mode is detected when the user selects the semi-autofocus mode from the plurality of focus modes such as the autofocus mode, the manual focus mode, semi-autofocus mode, etc. This selection operation is performed, for example, such that the user operates the configuration switch 129 on a menu image displayed on the display section 125. Operation information of the configuration switch 129 performed by the user is held as a parameter in the memory 123a in the system controller 123.

After the lens position LP1 is held, the system controller 123 reads out video signals from the image pickup element 124. Subsequently, the system controller 123 calculates evaluation values of the video signals in the respective focus adjustment areas (step S102). These evaluation values are, for example, contrast of the video signals. These evaluation values are obtained such that luminance signals are generated out of the video signals corresponding to the respective focus adjustment areas, and a difference between a maximum value and a minimum value of the generated luminance signals is calculated. In addition, in a case where only one area among the plurality of the focus adjustment areas is selected by way of the configuration switch 129, an evaluation value is calculated only within the selected area.

After the evaluation values are calculated, the system controller 123 holds, in the memory 123a, the evaluation values of the respective focus adjustment areas calculated in step S102, in such a manner that the evaluation values are associated with the present position LP1 of the focus lens 102 (step S103). However, the system controller 123 does not hold the evaluation values when the present position LP1 of the focus lens 102 is within an undetected area, which is determined by the lens position held in the previous processing. This processing of not holding the evaluation value is for fine controlling the driving of the focus lens 102 during an in-focus condition. The undetected area is determined by, for example, optical characteristics of the photographing optical system. For instance, if it is assumed that a range of focal depth of the photographing optical system is equal to an undetected area while having the previous lens position as a center of the range, the focus lens 102 is in an in-focus condition when it is in the undetected area. In this case, driving of the lens is unnecessary. Incidentally, characteristics of the photographing optical system may be obtained by reading out the lens data stored in the lens CPU 104 of the interchangeable lens 101 during powering on.

Furthermore, an undetected area may be set by a user. In this case, an undetected area is set such that, for example, a user operates the configuration switch 129 on the menu image displayed on the display section 125. With this operation, handling of, for example, setting the undetected area narrow in accordance with a photographing scene becomes possible. For instance, during a macro-photographing, the undetected area is to be set narrow since fine control of focus lens 102 is required.

Furthermore, when a driving amount of the focus ring 201 per unit of time is large (when the focus ring 201 is rotated quickly), the undetected area may be set wide. On the other hand, when a driving amount of the focus ring 201 per unit of time is small (when the focus ring is rotated slowly), the undetected area may be set narrow. Generally, users tend to rotate the focus ring 201 quickly when they want to move the focus lens 102 widely, and they tend to rotate the focus ring 201 slowly when they want to perform fine focus adjustment. Therefore, the undetected area is set wide for making focusing accuracy low when the focus ring 201 is rotated quickly, and the undetected area is set narrow for making focusing accuracy high when the focus ring 201 is rotated slowly. With the above manner, it is possible to perform focusing control that suits a user's purpose.

After step S103, the system controller 123 determines whether or not a peak of contrast is detected from the evaluation values held in step S103 (step S104). When a peak of contrast is not detected in the determination of step S104, the system controller 123 terminates processing shown in FIG. 3. The processing is performed again from step S101 of FIG. 3, when a predetermined time is elapsed after the termination of processing of FIG. 3.

On the other hand, when a peak of contrast is detected in the determination of step S104, the system controller 123 calculates a position of the focus lens 102 corresponding to an actual peak position (step S105). The actual peak position can be calculated with an interpolation calculation using evaluation values of the plurality of points (e.g., five points) that are assumed to include a peak of contrast. After the calculation of the peak position, the system controller 123 notifies the lens CPU 104 of a lens position corresponding to the peak of the contrast as a target lens position (step S106). The lens CPU 104 controls, in response to the notification of the target lens position, the lens driving section 103 to drive the focus lens 102 for performing focus adjustment.

After the focus adjustment of the focus lens 102, the system controller 123 performs a superimposed display on the image of the shooting subject displayed on the display section 125, so as to make a focus adjustment area that is in an in-focus condition viewable (step S107). Then the system controller 123 terminates the processing of FIG. 3. The processing is performed again from step S101 of FIG. 3, when a predetermined time is elapsed after the termination of processing of FIG. 3.

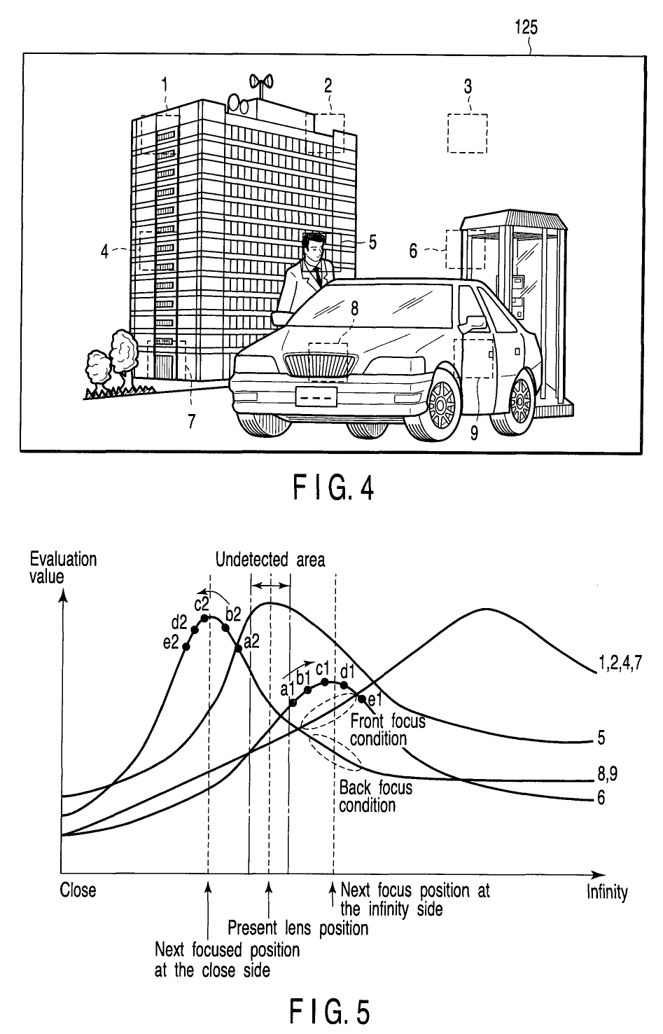

FIG. 4 is a drawing showing an example of a focus indicator. FIG. 4 shows an example in which focus adjustment area 5 is in an in-focus condition. At this time, focus adjustment area 5 is displayed in highlight, and the user is therefore able to know easily which shooting subject is presently in an in-focus condition.

Next, processing relating to automatic focus adjustment of steps S104-106 will be further explained. FIG. 5 is a chart showing relationships between positions of a focus lens and evaluation values, which correspond to respective focus adjustment areas.

FIG. 5 shows an example wherein the focus lens 102 is at a lens position at which focus adjustment area 5 is in an in-focus condition. When the focus ring 201 is operated toward the infinity side in the above condition, evaluation values of the respective focus adjustment areas are sequentially calculated every predetermined period of time. In the example of FIG. 5, evaluation values are calculated in each period of time in which the lens position is respectively at points a1, b1, c1, d1, and e1. For instance, when focus adjustment area 6 is the center of attention, the evaluation value in focus adjustment area 6 increases until the focus lens 102 comes to point c1, and it decreases after point d1. According to the present embodiment, a peak is recognized when a decrease in the evaluation value is sequentially detected at two of the points. Then an interpolation calculation is performed on the basis of the evaluation values at the five points including the peak (according to FIG. 4, points a1-e1). A peak position (a next in-focus position at the infinity side, shown in FIG. 5) is thereby calculated. After the calculation of the peak position, the focus lens 102 is driven to a position corresponding to the calculated peak position.

Similarly, when the focus lens 102 is operated from the present lens position of FIG. 5 toward the close side, a peak position (a next in-focus position at the close side, shown in FIG. 5) is calculated by using respective evaluation values of points a2-e2. Then, the focus lens 102 is driven to a position corresponding to the calculated peak position.

In the example of FIG. 5, a peak position is calculated based on detection results at the five points. However, it is possible to calculate a peak position on the basis of at least three points, when depth of field is deep and focus adjustment with high accuracy is less required. Furthermore, as described above, an evaluation value is not held and the subsequent focus adjustment of the focus lens 102 is not performed even if there are peaks of contrast in other focus adjustment areas, when the focus lens 102 is in the undetected area shown in FIG. 5.

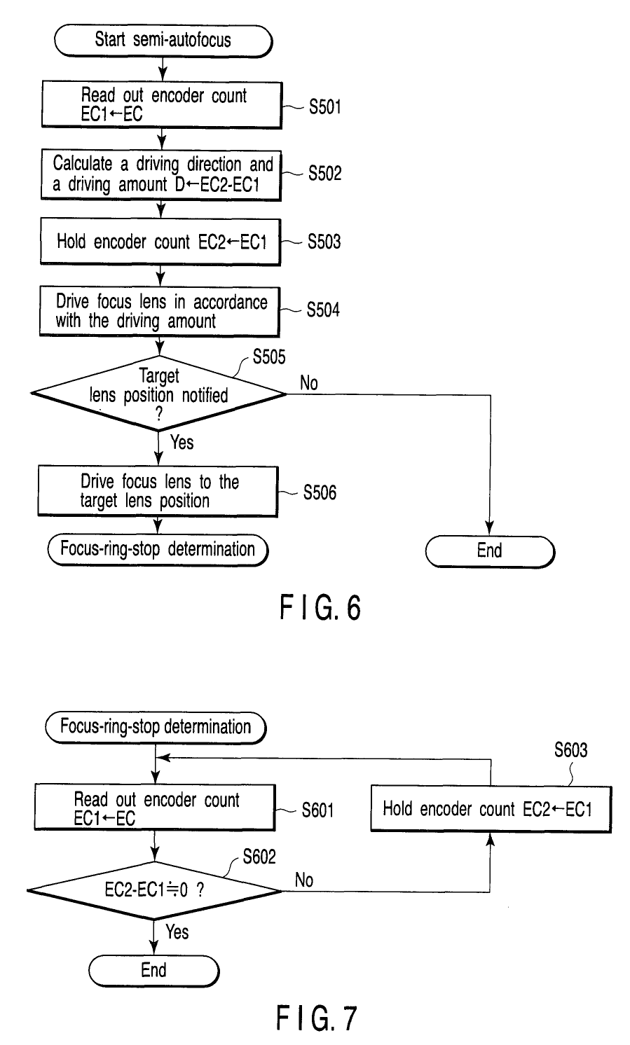

Next, processing of the lens CPU 104 during the semi-autofocus mode according to the first embodiment will be explained with reference to the flowchart of FIG. 6. As for FIG. 6, only processing related to the semi-autofocus mode will be explained. In reality, other processing is performed in parallel with the processing of FIG. 6. An example of other processing is to notify a position of the focus lens 102 when the system controller 123 inquires about a position of the focus lens 102.

During the semi-autofocus mode, rotary operation of the focus ring 201, which is a part of the focus adjustment mechanism 105, is transmitted to the encoder 106 via the focus adjustment mechanism 105. The encoder 106 converts a rotary operation amount of the focus ring 201 into a pulse signal and outputs the signal to the lens CPU 104. The lens CPU 104 counts the pulse signals from the encoder 106 by using a counter 104a included in the lens CPU 104. Then, the lens CPU 104 reads out a count value EC as count value EC1 indicating a present rotary operation amount of the encoder 106 (step S501). Subsequently, the lens CPU 104 calculates a driving amount D of the focus lens 102 on the basis of changes in the count value (step S502). The driving amount D is calculated with a formula D=EC2−EC1, that is to say, a difference between count value EC2 indicating the previous rotary operation amount of the encoder 106 and the present count value EC1. It is possible to determine a lens driving amount from the absolute value of D and a driving direction from a sign of D. Incidentally, processing of step S502 is not performed since count value EC2 cannot be obtained initially. A driving amount is therefore set to 0 initially.

Next, the lens CPU 104 holds count value EC1 which is read out in step S501 as count value EC2 (step S503). This count value EC2 held in step S503 is used for calculating driving amount D to be obtained in the next processing. After count value EC2 is held, the lens CPU 104 controls the lens driving section 103 for driving the focus lens 102 (step S504). Then, the lens CPU 104 determines whether or not a target lens position is notified by the system controller 123 (step S505). When the target lens position is notified in step S505, the lens CPU 104 stops (disabled) a drive of the focus lens 102 started in step S504, and controls the lens driving section 103 for driving the focus lens 102 to the target lens position (step S506). Afterward, the lens CPU 104 performs focus-ring-stop determination processing, which will be explained later. On the other hand, the lens CPU 104 terminates processing of FIG. 6 when the target lens position is not notified in step S505. The processing is performed again from step S501 of FIG. 6 when a predetermined time has elapsed after the termination of processing of FIG. 6.

Now, the focus-ring-stop determination processing will be explained with reference to FIG. 7. According to FIG. 7, the lens CPU 104 firstly reads out present count value EC1 of pulse signals from the encoder 106 (step S601). The lens CPU 104 then compares the read out count value EC1 with count value EC2, which is presently held by the lens CPU 104, for determining whether or not the both count values are equal (step S602). When it is determined that count value EC1 and count value EC2 are not equal in the determination of step S602, the lens CPU 104 determines that the rotary operation of the focus ring 201 is being continued. In this case, the lens CPU 104 holds the previous count value EC1 as count value EC2 (step S603). After that, processing goes back to step S601, and the lens CPU 104 again compares count value EC2 with count value EC1. In other words, in a case where a target position is notified and the focus lens 102 is driven, the next driving of the focus lens 102 is not performed until operation stop of the focus ring 201 is detected.

On the other hand, when count value EC2 and count value EC1 are equal in step S602, the lens CPU 104 terminates the processing, assuming that the rotary operation of the focus ring 201 is terminated. The processing is performed again from step S501 of FIG. 6, when a predetermined time has elapsed after the termination of processing of FIG. 7.

As explained above, according to the first embodiment, the contrast of video signals obtained from the image pickup element 124 is evaluated while moving the focus lens 102 in accordance with operation of the focus ring 201. When a peak of the contrast is found, operation of rotating the focus ring 201 is disabled and the focus lens 102 is stopped at a position at which the focus lens 102 is automatically in an in-focus condition With this mechanism, the target subject of shooting can easily be made in focus by simple operation of rotating the focus ring 201, which is performed by the user.

Furthermore, the focus adjustment mechanism according to the first embodiment is configured such that shooting subjects are sequentially focused in ascending order of distance from the camera in accordance with the rotary operation of the focus ring 201. Therefore, focus adjustment areas can be easily switched by adjusting the focus ring 201, and the user can quickly move onto photographing without having to change his/her photographing posture.

Also, once automatic focus adjustment of the focus lens 102 is performed, driving of the lens is not performed until rotary operation of the focus ring 201 is terminated. With this mechanism, misalignment of the focus, which is due to unnecessary movement of the focus lens 102 caused by over-operation of the focus ring 201 performed by the user, can be prevented.

Furthermore, when a position of the focus lens 201 is in an undetected area as a result of the operation of the focus ring 201, automatic focus adjustment is not performed. Therefore, fine driving of the focus lens 102 within a depth of field can be prevented.

According to the example of FIG. 4, when a focused position (peak position) is detected in accordance with rotary operation of the focus ring 201, a superimposed display is performed for making the detection information viewable. However, it is also possible to detect conditions related to focus other than the in-focus condition and display detected information, by using relationships between a driving direction of the focus lens 102 and changes in evaluation values. For example, a case in which a lens position at which a peak of focus adjustment area 6 is detected is considered. When evaluation values are detected while moving the focus lens 102 toward the infinity side from the lens position mentioned above, the evaluation value keeps increasing in focus adjustment area 1. This indicates that a peak of the contrast is further on the infinity side in focus adjustment area 1, and that focus adjustment area 1 is in a front focus condition with respect to a corresponding shooting subject. Also, an evaluation value keeps decreasing in focus adjustment area 8. This indicates that a peak of the contrast is more on the close side in focus adjustment area 8, and that focus adjustment area 8 is in a back focus condition with respect to a corresponding shooting subject.

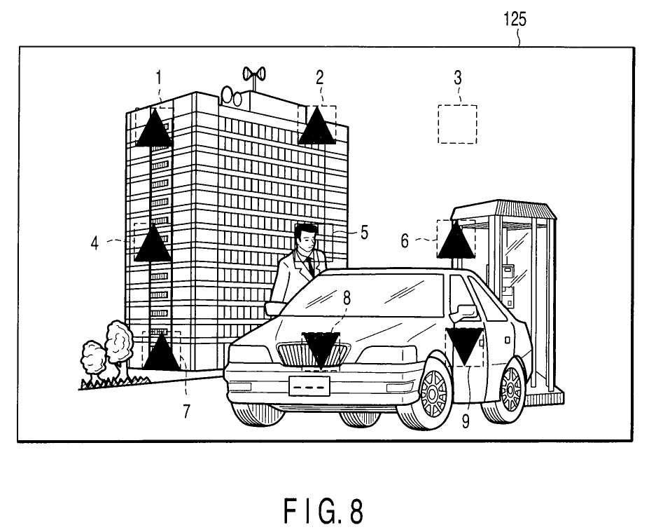

FIG. 8 shows an example in which information related to focus other than “in-focus”, such as “front focus” and “back focus”, is further superimposed on an image of the shooting subject. In FIG. 8, focus adjustment areas 1, 2, 4, 6, and 7, which are in front focus conditions with respect to in-focus focus adjustment area 5, are respectively indicated with lighted upward arrows, and focus adjustment areas 8 and 9, which are in back focus conditions with respect to in-focus focus adjustment area 5, are respectively indicated with lighted downward arrows. With these indicators, a user can easily know which direction to operate the focus ring 201. Incidentally, focus adjustment area 3 is an area in which focus detection was impossible due to low contrast.

### Second Embodiment

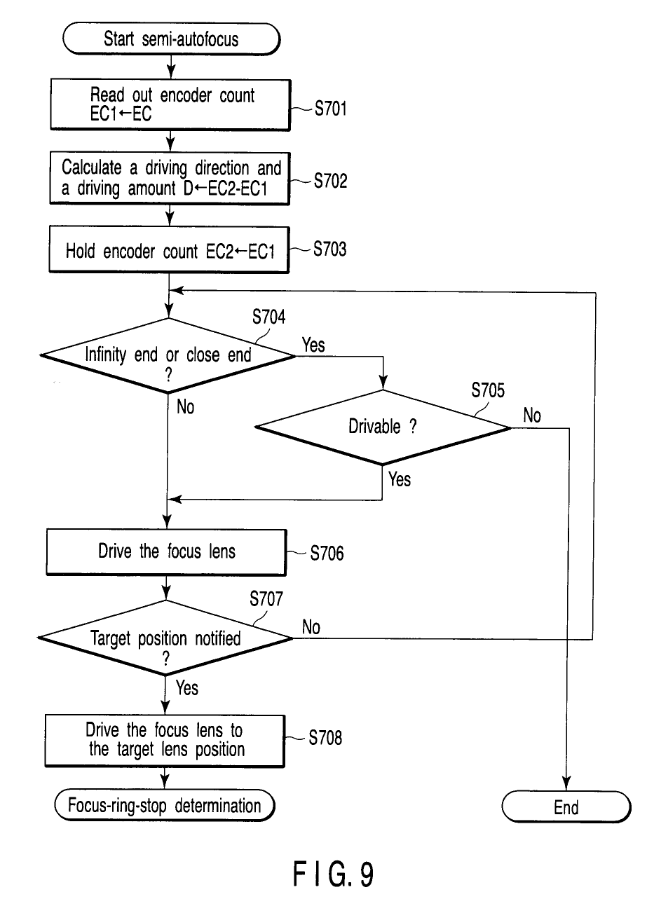

Next, the second embodiment of the present invention will be explained. A configuration and processing of a system controller 123 during a semi-autofocus mode of the second embodiment are similar to those of the first embodiment. Therefore, only processing of a lens CPU 104 during the semi-autofocus mode that is different from that of the first embodiment will be explained with reference to FIG. 9.

Firstly, the lens CPU 104 counts a pulse signal from an encoder 106 by using a counter 104a included in the lens CPU 104, when the semi-autofocus mode is started. The lens CPU 104 then reads out a count value EC as count value EC1 indicating a present rotary operation amount of the encoder 106 (step S701). Subsequently, the lens CPU 104 calculates a driving direction (sign of D) of the focus lens 102 on the basis of changes in the count value (step S702). Incidentally, processing of step S702 is not performed since count value EC2 cannot be obtained initially, and driving of the focus lens 102 is not performed.

Next, the lens CPU 104 holds count value EC1, which is read out in step S701, as count value EC2 (step S703). This count value EC2 held in step S703 is used for calculating the driving direction to be obtained in the next processing. After count value EC2 is held, the lens CPU 104 detects a present lens position for determining whether the focus lens 102 is on the close end (driving limit position on the close side) or on the infinity end (driving limit position on the infinity side) (step S704). When it is determined in the step S704 that the focus lens 102 is positioned on the close end or the infinity end, the lens CPU 104 determines whether or not the focus lens 102 is drivable (step S705). In other words, though the focus lens 102 can be driven toward the close side when the focus lens 102 is on the infinity end, it cannot be driven toward the infinity side. On the other hand, though the focus lens 102 can be driven toward the infinity side when the focus lens is 102 on the close end, it cannot be driven toward the close side. Therefore, the determination of step S705 is performed in such a manner that when the focus lens 102 is on the infinity end, it is determined whether or not a driving direction of the lens is toward the close side, and that when the focus lens 102 is on the close end, it is determined whether or not a driving direction of the lens is toward the infinity side. When the focus lens 102 is not drivable as a result of the determination of step S705, the lens CPU 104 terminates processing of FIG. 9.

When the focus lens 102 is on neither the close end nor the infinity end in the determination of the step S704, or when the focus lens 102 is drivable in the determination of step S705, the lens CPU 104 controls the lens driving section 103 for starting diving of the focus lens 102 toward the driving direction determined in step S702 (step S706). Subsequently, the lens CPU 104 determines whether or not a target lens position is notified by the system controller 123 (step S707). When the target lens position is notified in the determination of step S707, the lens CPU 104 controls the lens driving section 103 for driving the focus lens 102 to the target lens position (step S708). Afterward, focus-ring-stop determination processing shown in FIG. 7 is performed.

As explained in the first embodiment, the focus-ring-stop determination processing prevents misalignment of the focus due to further movement of the focus lens after the automatic focus adjustment. However, the focus-ring-stop determination processing is not necessarily performed. Also, an advantage similar to the focus-ring-stop determination processing can be obtained merely by waiting for a predetermined time (about 1 second) after the automatic focus adjustment.

Furthermore, when a target lens position is not notified in the determination of step S707, the lens CPU 104 again performs processing from step S704 onward. That is to say, in the second embodiment, the focus lens 102 is kept driving until a target lens position is notified, or until the focus lens 102 reaches the close end or the infinity end and further lens driving becomes impossible.

As explained above, according to the second embodiment, the focus lens 102 is kept driving in accordance with a driving direction of the focus ring 201 until the next shooting subject is focused. With this mechanism, focus adjustment on a shooting subject can be performed even if a rotary operation amount of the focus ring 201 is small. Therefore, quick focus adjustment is possible and is advantageous in stabilizing images.

In each of the above embodiments, a case where an image pickup apparatus is a single-lens reflex camera with an interchangeable lens is explained. However, the present embodiments are not necessarily applied only to a camera with an interchangeable lens. Also, although the above examples described a case where nine focus adjustment areas are provided within a photographing filed, the present invention is not limited to this example. Furthermore, in the example of FIG. 8, front focus conditions are indicated with upward arrows and back focus conditions are indicated with downward arrows for showing information related to focuses. However, this information may be expressed with a color shading on the basis of a defocus amount with respect to an in focus position.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image pickup apparatus comprising:
an optical system which forms an image of a shooting subject;
a driving section which drives the optical system;
a focus operation section which transmits a driving direction and a driving amount of the optical system on the basis of a manual operation;
an image pickup element which converts the image of the shooting subject formed by the optical system into a video signal;
an evaluation section which evaluates a focus condition of at least one area within a photographing field on the basis of the video signal from the image pickup element; and
an autofocus adjustment section which adjusts focus of the optical system in such a manner that the autofocus adjustment section disables a transmission of the driving direction and the driving amount of the optical system by the focus operation section when the auto focus adjustment section detects an area which is determined to be focus from a result of the evaluation of the focus condition of at least one area performed by the evaluation section in conjunction with driving of the optical system by the focus operation section on the basis of a manual operation, and the autofocus adjustment section selects the area which is determined to be focused and drives the optical system to a position corresponding to the area determined to be focused.

2. The image pickup apparatus according to claim 1, wherein the autofocus adjustment section selects an area which is first determined to be focused from among the at least one area, and drives the optical system.

3. The image pickup apparatus according to claim 1, further comprising an area selection section which selects an area within the photographing field, wherein
the evaluation section evaluates a focus condition of only an area selected by the area selection section.

4. The image pickup apparatus according to claim 1, wherein the driving section holds a condition in which the optical system is stopped until an operation stop of the focus operation section is detected, after a focus adjustment performed by the autofocus adjustment section.

5. The image pickup apparatus according to claim 1, wherein the evaluation section performs an evaluation of the focus condition only when a driving amount of the optical system driven by the driving section is equal to or greater than a predetermined threshold value.

6. The image pickup apparatus according to claim 5, wherein the predetermined threshold value is determined in accordance with a characteristic of the optical system.

7. The image pickup apparatus according to claim 5, wherein the predetermined threshold value is determined in accordance with a manual operation amount per unit of time of the focus operation section.

8. The image pickup apparatus according to claim 5, further comprising a threshold value setting section which sets the predetermined threshold value.

9. The image pickup apparatus according to claim 1, further comprising a display section which displays an image on the basis of the video signal, wherein
the display section performs a superimposed display on an area of the image corresponding to the area that is determined to be focused, for indicating that the area determined to be focused is selected.

10. The image pickup apparatus according to claim 9, wherein
the autofocus adjustment section further determines, on the basis of an evaluation result by the evaluation section and a driving direction of the optical system, focus conditions of areas other than the area determined to be focused,
the display section performs a superimposed display on areas of the image respectively corresponding to the areas other than the area determined to be focused, for indicating a plurality of focus conditions of the areas other than the area determined to be focused.

11. The image pickup apparatus according to claim 1, wherein the driving section keeps driving the optical system until the area determined to be focused is selected or up to a driving limit of the optical system, after a start of the driving of the optical system.
